(19) United States
(12) Patent Application Publication
(10) Pub. No.: US 2004/0208684 A1
(43) Pub. Date: Oct. 21, 2004

(54) Notebook having removable pages

(75) Inventor: Gene Anderson, Oberursel (DE)

Correspondence Address: DAVIDSON, DAVIDSON & KAPPEL, LLC, 485 SEVENTH AVENUE, 14TH FLOOR, NEW YORK, NY, 10018, US

(73) Assignees: Gene Anderson, Oberursel (DE); Barbara Anderson, Oberursel (DE)

(21) Appl. No.: 10/686,443

(22) Filed: Oct. 14, 2003

Related U.S. Application Data
(60) Provisional application No. 60/418,948, filed on Oct. 15, 2002.

(51) Int. Cl. B42F 13/00

(52) U.S. Cl. 402/73

(57) ABSTRACT

A notebook (1) includes a base (2) having a front side and a rear side, as well as first retaining device (10) disposed at a first distance (8) from a first peripheral edge (4) for securing a writing medium (18) of a first size to the front side of the base (2). At a second distance (20) from the first peripheral edge (4) of the base (2), second retaining device is provided, which is used to fasten a second individual writing medium (26), in the form of a sheet, having a different size than the first writing medium (18). The first retaining device includes a first strip (10) of thin material which, within the span of the first distance (8), extends from a first side edge (12) to a second side edge (14), substantially in parallel to the first peripheral edge (4) of the base (2) in such a way that the corresponding edge (16) of the first writing medium (18) is slideable underneath the first strip (10), in order to secure the same to the base (2).

The present invention is directed to a notebook having removable pages according to the definition of the species in claim 1.

Notebooks have been known for quite some time. Their purpose is to provide a user with one or more slips of notepaper on which he/she can jot down ideas, notes, thoughts, etc., in the form of handwritten notes.

From the German Utility Model Patent G 89 02 907 U1, a notebook is known which includes a holder for self-adhesive notepaper, which, on its bottom side, has a flap which is insertable into a pocket formed on the base of the notebook for securing the holder. The design of the notebook makes it unsuitable for holding a plurality of individual loose slips of notepaper of different sizes, without the notepaper being fastened to a holder, so that the only way to replenish the notepaper is to replace the entire holder pad, together with all of the notepaper that is attached thereto. This makes the notebook quite thick, thereby adversely affecting the comfort and convenience of the person carrying the notebook.

Accordingly, it is an object of the present invention to devise a notebook which will have a small thickness and make it possible for two different paper sizes to be accommodated, in particular one standard size for notepaper used in Europe, as well as one for notepaper used in the United States.

This objective is achieved in accordance with the present invention by the features set forth in claim 1.

Other features of the present invention are described in the dependent claims.

The present invention is described in the following with reference to the drawings, on the basis of preferred embodiments.

In the drawings, the figures show:

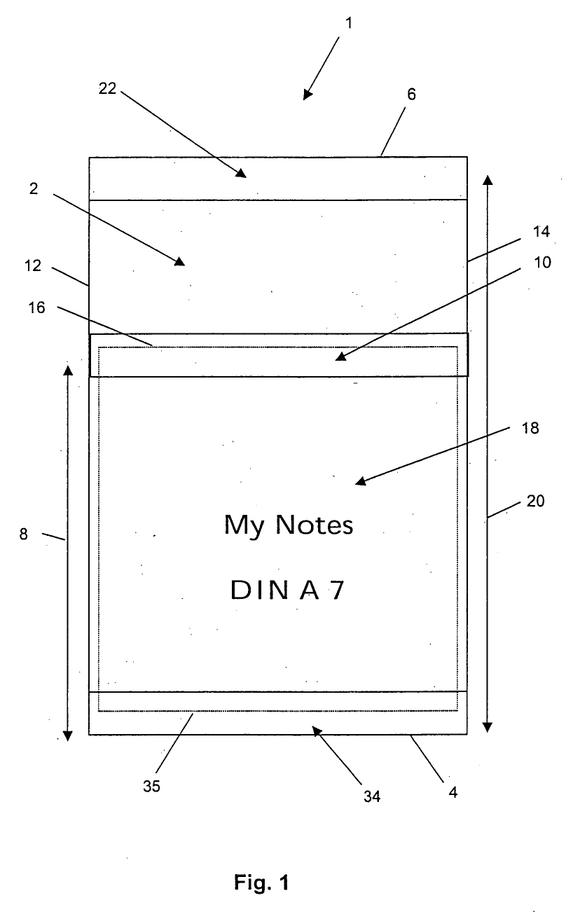

FIG. 1 a schematic representation of the notebook or notepad of the present invention, on whose front side a writing medium of a first small size is held by the first retaining means;

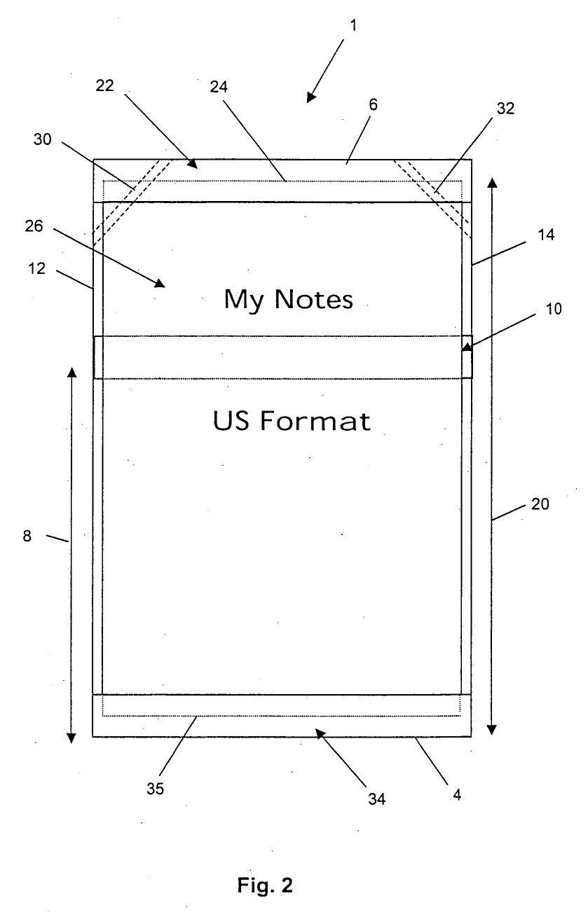

FIG. 2 a schematic representation of the notebook or notepad of the present invention, on whose front side a writing medium of a second larger size is held by the second retaining means; and

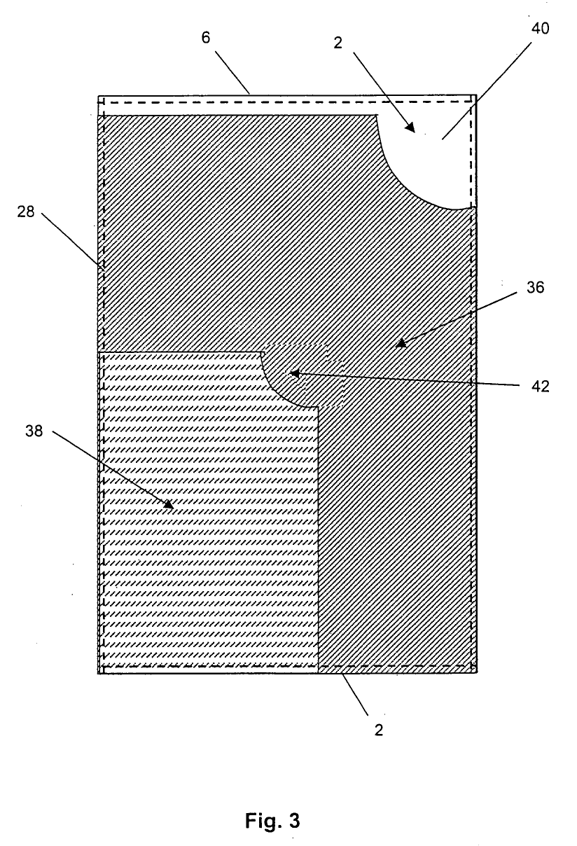

FIG. 3 a schematic rear view of the notebook according to the present invention for illustrating the position of the first and second pockets for accommodating the writing medium that has just been written on, as well as business cards of different sizes.

As shown in FIG. 1, a notebook or a notepad 1 according to the present invention includes a substantially rectangular base 2, which has a front side, as shown in FIG. 1, and a rear side, as shown in FIG. 3, as well as a first bottom peripheral edge 4 and a second top peripheral edge 6. Base 2 is preferably manufactured from leather or artificial leather and, in accordance with the preferred embodiment of the present invention, has a width in the range of 82 mm and a height in the range of 134 mm; however, it may also have different dimensions.

On the front side of base 2, at a first distance 8, indicated by the left double arrow (FIGS. 1 and 2), from first peripheral edge 4, first retaining means in the form of a first strip 10 of thin material, for example of plastic film, are fastened and extend within the span of first distance 8 substantially in parallel to first peripheral edge 4 of base 2, from a first peripheral side edge 12 to a second peripheral side edge 14 of the same. In this context, strip 10, which may have a width of 13 mm, for example, is secured to base 2 in such a way that corresponding edge 16 of a first individual writing medium 18, in the form of a sheet, is slideable underneath first strip 10, in order to secure first writing medium 18, in particular a loose slip of notepaper, to base 2. First writing medium 8 has a first format, which, in the preferred embodiment of the present invention, has dimensions in the range of 74 mm×105 mm (DIN A7). In this embodiment of the present invention, first distance 8 preferably has a magnitude of 100 mm, but may also have a different value.

As is also shown in FIGS. 1 and 2, at a second distance 20, indicated by the left double arrow in FIGS. 1 and 2, from first peripheral edge 4 of base 2, second retaining means 22 are disposed, which detachably secure corresponding edge 24 of a second individual writing medium 26, in the form of a sheet, to base 2. In this connection, in the manner of the present invention, at a size of 76.23 mm (3 inches)×127.05 mm (5 inches), as is often used in the United States, the format of second writing medium 26 is enlarged as compared to first writing medium 18. However, if desired, first and/or second distances 8, 20 may also have a different magnitude.

By using a base in combination with two different retaining means 10, 22, one derives the advantage that notebook 1 in accordance with the present invention may be used in Europe, as well as in the United States, without any limitations, the particular benefit being that only a few loose sheets, for example five sheets, of first writing medium 18 or of second writing medium 26 are always able to be secured to base 2 by corresponding retaining means 10, 22. As a result, notebook 1 according to the present invention is able to be kept extremely thin and flexible, enabling it to fit in every shirt pocket, jacket pocket, or pants pocket, without being irritatingly bulky or outwardly visible. In addition, because of the comparatively low number of writing media 18, 26, the notebook has a low weight. This likewise has a very beneficial effect on the comfort and convenience of the wearer.

By embodying the first retaining means as thin, film-type strip 10 having a thickness of, for example, 0.15 mm and a width in the range of 13 mm, it is ensured that, when writing on first writing medium 18, its edge 16 is held securely to base 2. At the same time, care is taken to ensure that film-type strip 10—which is disposed underneath second writing medium 26 while larger second writing medium 26 is written on—does not interfere with or become apparent in the impression of the handwritten notes. In this connection, the fastening points of the thin film-type strip are preferably located outside of the surface covered by second writing medium 26, in the area of right side edge 12 and of left side edge 14 of base 2.

In the same way, the second retaining means may include a second strip 22 of thin film-type material which, within the span of second distance 20, extends from first side edge 12 across to second side edge 14, substantially in parallel to first peripheral edge 4 of base 2, and is fastened, for example, in the area of second peripheral edge 6 of base 2 by stitching or bonding, forming a pocket in such a way that corresponding edge 24 of second writing medium 26 is slideable underneath second strip 22. Here, the advantage is derived that the first and/or second retaining means may be manufactured from one and the same material, so that manufacturing costs are reduced.

Alternatively, it may likewise be provided for the second retaining means to be fabricated as a first and second loop-shaped band 30, 32, for example of leather, artificial leather, or likewise of film, which is secured by its ends to base 2 in such a way that it extends preferably at a 45° angle from the corresponding right and left side edge 12, 14 of base 10 over the corresponding corners of second writing medium 26, in order to press the corners of second writing medium 26 against base 2 and, in this way, secure writing medium 26 to base 2.

In the preferred embodiment of the present invention, further retaining means 34 are formed in the area of first peripheral edge 4 of base 2 and are preferably designed in the same way as second retaining means 22, as pockets, into which corresponding edge 35 of first and second writing media 10, 18 is insertable. As a result, one derives the benefit that all retaining means 10, 22 and 34 may be manufactured with identical dimensions, from one and the same material, in particular from thin plastic film, which is then bonded, stitched, or joined in some other way to the base.

In accordance with another embodiment of the present invention illustrated in FIG. 3, which provides an advantageous way to store the first and/or second writing media 18, 26, that have just been written on, on the rear side of base 2, a first pocket 36 is provided into which first writing medium 18 and/or second writing medium 26 are insertable after being written on.

Moreover, provision may also be made on the rear side of base 2 for a second pocket 38 in which one or more business cards may be stored.

As can be inferred in detail from the representation of FIG. 3, second pocket 38 has a substantially rectangular form, two of the side edges of pocket 38 preferably being fastened in the area of bottom peripheral edge 4 of base 2, as well as in the area of left peripheral side edge 12 of the same, by stitching or bonding to base 2, in a way that enables business cards of different sizes to be accommodated in second pocket 38.

In addition, provision may be made for one of the corners of first pocket 36 and preferably also of second pocket 38 to have an arc-shaped cut-out 40, 42. This allows the user of notebook 1 according to the present invention to discern very easily, from the outside, whether there is a writing medium 18, 26, that has been written on, in first pocket 36, or a business card in second pocket 38. In addition, arc-shaped cut-outs 40, 42 make it possible for the user to grasp the writing media or the business cards very easily by his/her fingertips and to pull them out of pocket 36, 38 in question without any great effort.

The previously described embodiment of notebook 1 according to the present invention has the advantage of being able to be manufactured very simply and cost-effectively, in that the individual parts prepared for the first, second, and further retaining means 10, 22, 35, for base 2, as well as for first and second pocket 36, 38, respectively, are positioned one over another, and subsequently stitched together in the area of peripheral side edges of the base, as indicated in FIG. 3 by seam 28. For the sake of clarity, seam 28 is not marked in FIGS. 1 and 2.

Reference Symbols

1 notebook

2 base

4 first peripheral edge

6 second peripheral edge

8 first distance

10 first retaining means

12 right peripheral side edge

14 left side edge

16 edge of first writing medium

18 first writing medium

20 second distance

22 second retaining means

24 edge of the second writing medium

26 second writing medium

28 seam

30 first loop-shaped band

32 second loop-shaped band

34 further pocket-shaped retaining means

35 bottom edge of first and second writing medium

36 first pocket

38 second pocket

40 first cut-out

42 second cut-out

1 to 15 (canceled).

16 A notebook comprising:
a base having a front side and a rear side and having a first side edge and a second side edge and a first peripheral edge;
a first retaining device for securing a first writing medium having a first size to the front side of the base, the first retaining device being disposed at a first distance from the first peripheral edge;
a second retaining device provided at a second distance from the first peripheral edge for securing a second individual writing medium in the form of a sheet having a different size than the first writing medium;
the first retaining device including a first strip of thin material, the first strip, within a span of the first distance, extending from the first side edge to the second side edge, substantially in parallel to the first peripheral edge of the base so that a corresponding edge of the first writing medium is slideable underneath the first strip to secure the first writing medium to the base.

17 The notebook as recited in claim 16 wherein the second retaining device include a second strip of thin material, the second strip, within the span of the second distance, extending from the first side edge to the second side edge substantially in parallel to the first peripheral edge of the base so that a second corresponding edge of the second writing medium is slideable underneath the second strip to secure the second writing medium to the base.

18 The notebook as recited in claim 16 wherein the second retaining device includes a first and second loop-shaped band secured at ends to the base so that the first and second bands extend at an angle to the first and second side edges of the base over corresponding corners of the second writing medium to secure the corners of the second writing medium to the base.

19 The notebook as recited in claim 18 wherein the first and the second bands are disposed at a 45° angle.

20 The notebook as recited in claim 16 wherein the base is manufactured from a flexible material.

21 The notebook as recited in claim 20 wherein the flexible material is leather or plastic.

22 The notebook as recited in claim 16 wherein the base has a width in the range of 82 mm.

23 The notebook as recited in claim 16 wherein the base has a height in the range of 134 mm.

24 The notebook as recited in claim 16 wherein the first distance is in the range of 100 mm.

25 The notebook as recited in claim 16 wherein the first and/or the second retaining device are stitched to the base.

26 The notebook as recited in claim 16 wherein, in the area of the first peripheral edge of the base, a further pocket-shaped retaining device is formed, into which a corresponding edge of the first and second writing media is insertable.

27 The notebook as recited in claim 16 wherein, on the rear side of the base, a first pocket is provided for inserting the first writing medium and/or the second writing medium after being written on.

28 The notebook as recited in claim 27 wherein one of the corners of the first pocket is provided with an arc-shaped cut-out.

29 The notebook as recited in claim 16 wherein, on the rear side of the base, a second pocket is provided for accommodating one or more business cards.

30 The notebook as recited in claim 29 wherein the second pocket has a substantially rectangular form, and two side edges of the pocket are fastened to the base in the area of the first peripheral edge of the base, as well as in the area of one of the first and second side edges.

31 The notebook as recited in claim 29 wherein one of the corners of the second pocket is provided with an arc-shaped cut-out.
